(19) United States
(12) Patent Application Publication
(10) Pub. No.: US 2023/0162699 A1
(43) Pub. Date: May 25, 2023

(54) OPTICAL FIBER CONNECTION DEVICE AND DISPLAY DEVICE APPLYING SAME

(71) Applicant: LT ELECTRONICS CO., LTD., Gyeonggi-do (KR)

(72) Inventors: Soon Kyo HONG, Gyeonggi-do (KR); Hyun Phill HONG, Gyeonggi-do (KR)

(21) Appl. No.: 17/915,594

(22) PCT Filed: Jul. 26, 2021
(86) PCT No.: PCT/KR2021/009631

§ 371 Date: Sep. 29, 2022

(30) Foreign Application Priority Data
Nov. 12, 2020 (KR) 10-2020-0151336

(51) Int. Cl. G09G 5/02; G02B 6/04; F21V 8/00

(52) U.S. Cl. CPC G09G 5/02; G02B 6/04; G02B 6/0008

(57) ABSTRACT

Provided are an optical fiber connection device and a display device applying same, the display device including: a body detachably coupled to an object to be installed; an optical fiber display made of one or more optical fibers; a light source unit installed inside the body and including one or more light sources; and an optical fiber connection device for connecting the light source unit and the optical fiber display so that light emitted from the light source unit is incident into one end of the optical fiber display, wherein the optical fiber display is coupled into a space provided in the optical fiber connection device in a sliding manner, so that the light source unit and the optical fiber display can be easily connected.

### TECHNICAL FIELD

The present invention relates to an optical fiber display device, and more particularly, to an optical fiber connection device for connecting an optical fiber to a light source, and a display device applying the optical fiber connection device.

### BACKGROUND ART

Recently, a fabric lighting device or a display device using LEDs and optical fibers has been developed.

The optical fiber refers to an optical fiber in which a core having a high refractive index is disposed at a center of the optical fiber, and a cladding having a relatively low refractive index is disposed in an outer portion of the optical fiber, so that total reflection of a light passing through the core occurs.

Such an optical fiber has a very low energy loss, so that a loss rate of transmitted and received data is also low, and the optical fiber is rarely influenced by external factors.

In addition, an optical fiber in which both a core and a cladding are formed of a light-transmitting plastic material is referred to as a plastic optical fiber (POF), and the plastic optical fiber (POF) has excellent flexibility and is strong against vibrations or bending as compared with an optical fiber formed of glass.

The applicant has disclosed a display device using an optical fiber and a technology for manufacturing the display device in many documents such as Patent Documents 1 and 2 set forth below and obtained the patent right by filing the patent documents.

Patent Document 1 relates to a display device using an optical fiber, which transmits and displays a screen of a small imaging device to a large screen.

Patent Document 2 discloses configurations of a method and an apparatus for manufacturing an optical fiber display module, in which a plurality of optical fibers are arranged to have a predetermined area, and an outer surface of the arrangement of the optical fibers is coated with a laminating film, so that a light divergence area may be widened, and breakage may be prevented so as to improve durability.

Meanwhile, FIG. 1 is a view showing a configuration of an optical fiber display device according to the related art.

As shown in FIG. 1, according to the related art, an optical fiber display device 1 may include: a plurality of optical fibers 2 installed such that an exposure part 3 is formed on a top surface of a material; a light source unit 4 for emitting a light or an image to an end of the optical fiber 2; and a control unit (not shown) for supplying a power to the light source unit 4 and controlling an on/off operation.

The optical fibers 2 may be individually connected to the light source unit, or may be connected to the light source unit 4 through a bundle part 5 in which rear ends of the optical fibers 2 are bundled together as shown in FIG. 1.

However, according to the optical fiber display device of the related art, even when the light source unit is connected through the bundle part 5, individual optical fibers bundled as the bundle part have to be inserted and coupled into a plurality of insertion holes formed in a connector 6 one by one.

As described above, according to the optical fiber display device of the related art, the individual optical fibers or optical fiber bundles have to be inserted and coupled into the insertion holes formed in the connector one by one, so that workability may be reduced, and human, time, and economic costs required for a manufacturing work may be increased.

In addition, according to the optical fiber display device of the related art, light sources are in one-to-one correspondence with the optical fibers, so that colors other than a light emitted from the light source unit or colors obtained by mixing mutually different colors may not be displayed.
(Patent Document 1) Korean Patent Registration No. 10-1275153 (published on Jun. 17, 2013)
(Patent Document 2) Korean Patent Registration No. 10-1241233 (published on Mar. 11, 2013)

### DISCLOSURE

### Technical Problem

To solve the problems described above, an object of the present invention is to provide an optical fiber connection device and a display device applying the same, capable of easily connecting an optical fiber to a light source.

Another object of the present invention is to provide an optical fiber connection device and a display device applying the same, capable of displaying various colors by mixing colors with each other in addition to a color emitted from a light source unit.

### Technical Solution

To achieve the objects described above, according to the present invention, there is provided an optical fiber connection device, wherein the optical fiber connection device is formed therein with a fixing space to which one end of the optical fiber display is fixed through one surface of the optical fiber connection device, which is opened, the optical fiber connection device is formed on an opposite surface thereof with one or more installation holes in which one or more light sources provided in the light source unit are installed, and an arrangement space in which a lens unit for condensing lights emitted from the light sources provided in the light source unit is disposed is formed between the installation holes and the fixing space.

In addition, to achieve the objects described above, according to the present invention, there is provided a display device applying an optical fiber connection device, the display device including: a body detachably coupled to an installation object; an optical fiber display fabricated by using one or more optical fibers; a light source unit installed inside the body and including one or more light sources; and the optical fiber connection device for connecting the light source unit to the optical fiber display so that a light emitted from the light source unit is incident into one end of the optical fiber display.

### Advantageous Effects

As described above, according to the optical fiber connection device and the display device applying the same of the present invention, the optical fiber display may be slidably coupled into a space provided in the optical fiber connection device, so that the light source unit and the optical fiber display can be easily connected to each other.

Accordingly, according to the present invention, workability of a manufacturing work of the display device using an optical fiber can be improved, and human, time, and economic costs required for the manufacturing can be minimized.

In addition, according to the present invention, a light emitted from the light source unit may be condensed in a line shape through the lens unit so as to be incident into the one end of the optical fiber display having a fabric shape, so that light efficiency can be improved.

In addition, according to the present invention, the lights emitted from the light sources may be mixed with each other while being incident into the optical fiber display through the lens unit, so that the optical fiber display can display colors mixed with each other in addition to colors emitted from the light sources.

Accordingly, according to the present invention, various shapes such as pictures, designs, and characters may be displayed in various colors through the optical fiber display, so that a visual effect and an aesthetic impression can be improved.

### DESCRIPTION OF DRAWINGS

FIG. 1 is a view showing a configuration of an optical fiber display device according to the related art.

FIG. 2 is a perspective view showing a display device applying an optical fiber connection device according to an exemplary embodiment of the present invention.

FIG. 3 is a partially enlarged view showing the display device.

FIG. 4 is a side view showing the display device of FIG. 2.

FIG. 5 is a perspective view showing the optical fiber connection device according to the exemplary embodiment of the present invention.

FIG. 6 is a perspective view showing the optical fiber connection device of FIG. 5 from another angle.

FIG. 7 is a view illustrating a state in which a light emitted from a light source of a light source unit is emitted through a lens unit.

FIG. 8 is a view showing an actual lighting state of an optical fiber display.

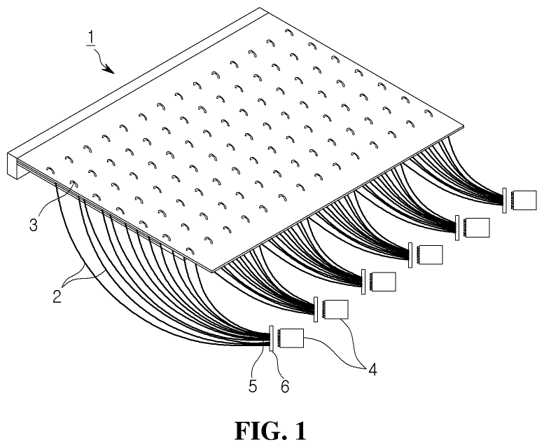

### MODE FOR INVENTION

Hereinafter, an optical fiber connection device and a display device applying the same according to an exemplary embodiment of the present invention will be described in detail with reference to the accompanying drawings.

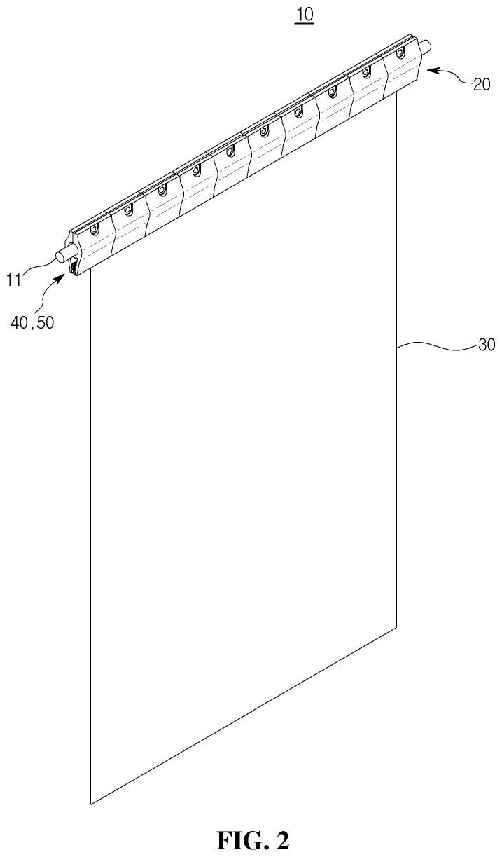

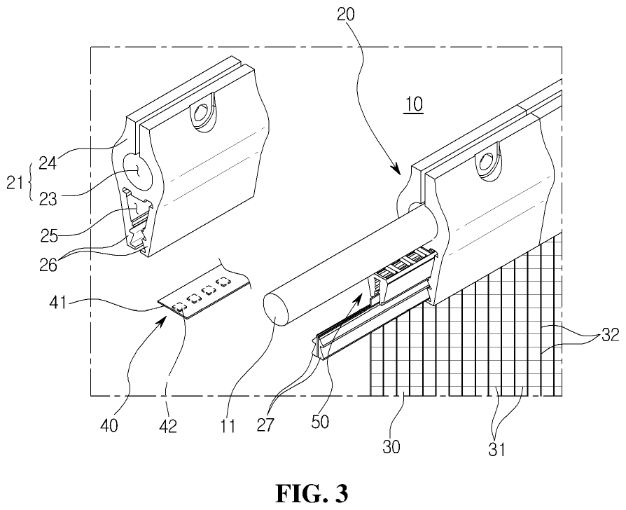

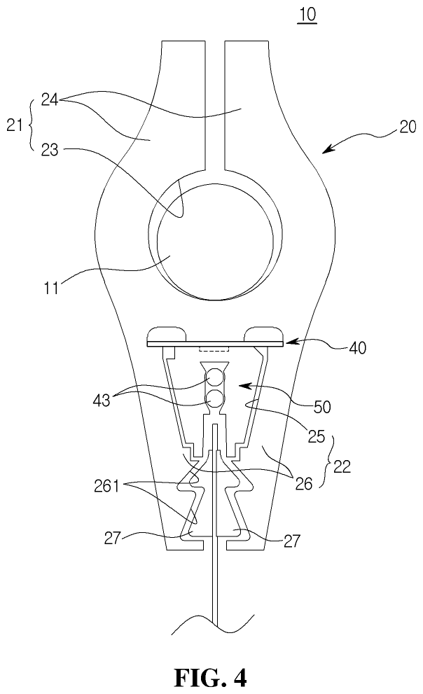

FIG. 2 is a perspective view showing a display device applying an optical fiber connection device according to an exemplary embodiment of the present invention, FIG. 3 is a partially enlarged view showing the display device, and FIG. 4 is a side view showing the display device of FIG. 2.

Hereinafter, terms indicating directions such as ‘left’, ‘right’, ‘front’, ‘rear’, ‘upward’, and ‘downward’ will be defined as indicating respective directions based on a state shown in each drawing.

According to the present embodiment, a configuration in which an optical fiber display device 10 is installed in a vertical direction on an installation object 11 arranged in a horizontal direction will be described.

However, the present invention is not necessarily limited to the above embodiment, and a change may be made so that the optical fiber display device 10 is installed in left and right directions on the installation object 11 installed in the vertical direction as in a flagpole.

In addition, an optical fiber connection device 50 may be disposed on one side or both sides of an optical fiber display 30.

Further, the optical fiber display 30 is not limited to a substantially rectangular shape, and may be formed in a polygonal shape such as a triangular or pentagonal shape, or a circular or oval shape.

Therefore, the optical fiber connection device 50 may be variously deformed in a shape bent at various angles more than once or a curved shape as well as a bar shape that is a straight line shape.

As shown in FIG. 2, the display device 10 applying the optical fiber connection device according to an exemplary embodiment of the present invention may include: a body 20 detachably coupled to an installation object 11; an optical fiber display 30 fabricated by using one or more optical fibers 31; a light source unit 40 installed inside the body 20 and including one or more light sources 42; and an optical fiber connection device 50 for connecting the light source unit 40 and the optical fiber display 30 so that a light emitted from the light source unit 40 is incident into one end of the optical fiber display 30.

In addition, the display device 10 applying the optical fiber connection device according to the exemplary embodiment of the present invention may further include a control unit (not shown) for supplying a power to the light source unit 40 and controlling driving of each of the light sources 42.

An installation part 21 in which the installation object 11 having a shape of a flagpole is installed may be provided on one side of the body 20, which is an upper portion when viewed in FIG. 3, and a coupling part 22 coupled to the optical fiber connection device 50 and the optical fiber display 30 may be provided in a lower portion of the body 20.

The installation part 21 may be formed at a center thereof with an installation space 23 in which the installation object 11 is installed, and the installation part 21 may include a pair of installation members 24 separately provided on both sides of the installation space 23, that is, on front and rear sides of the installation space 23.

In other words, the pair of installation members 24 may be deformed so as to move away from each other on both sides by using elasticity, and the installation object 11 disposed in the installation space 23 may be firmly fixed by using fastening bolts and nuts according to a diameter of the installation object 11.

To this end, a fastening hole to which each of the fastening bolts is fastened may be formed at an outer end of each of the installation member 24, which is an upper end when viewed in FIG. 3.

The coupling part 22 may be formed with a coupling space 25 in which the light source unit 40, the optical fiber connection device 50, and the optical fiber display 30 are coupled, and the coupling part 22 may include a pair of coupling members 26 separately provided on both sides of the coupling space 25.

A fixing groove 261 to which a fixing member 27 for firmly fixing the optical fiber display 30 by pressing the optical fiber display 30 from front and rear sides of the optical fiber display 30 while the optical fiber display 30 is coupled to the coupling space 25 is coupled may be formed between the pair of coupling members 26.

A pair of fixing members 27 may be provided so as to be disposed on both sides, that is, front and rear sides of an upper end of the optical fiber display 30. However, the present invention is not necessarily limited to the above embodiment, and a change may be made so that only one fixing member 27 is applied to the front or rear side of the optical fiber display 30.

The fixing member 27 and the fixing groove 261 may be formed in shapes corresponding to each other.

For example, as shown in FIG. 3, the fixing member 27 and the fixing groove 261 may have a section having one or more substantially triangular shapes. However, the present invention is not necessarily limited to the above embodiment, and the fixing member 27 and the fixing grooves 261 may have a section having a shape that is variously changed, such as a polygonal shape and a semicircular shape.

As described above, according to the present invention, the fixing member may be installed between the body and the optical fiber display coupled to a lower end of the body, so that the optical fiber display may be prevented from being separated by vibrations or impacts applied from an outside.

The body 20 configured as described above may be divided into a plurality of modules having a preset width, and may be configured such that one or more modules are consecutively arranged to correspond to a lateral length of the optical fiber display 30.

The body 20 may be preferably formed of a metal material having excellent heat dissipation performance, such as aluminum, or a synthetic resin material so that the body 20 may receive heat generated from the light source unit 40 and effectively discharge the heat to the outside.

The optical fiber display 30 may be fabricated by using only one or more optical fibers 31.

However, the present invention is not necessarily limited to the above embodiment, and the optical fiber display 30 may be fabricated in a weaving scheme by using a combination of the optical fiber 31 and a general fiber 32 as shown in FIG. 3, or may be fabricated in a nonwoven scheme by using a combination of the optical fiber 31 and a material that is applicable to a nonwoven fabric.

The optical fiber 31 may have an exposure part formed over an entire optical fiber 31 or in a portion of the optical fiber 31 so as to emit a light through an outer surface of the optical fiber display 30.

Therefore, the optical fiber display 30 may display pictures, designs, characters, and the like having various shapes by emitting the light through the exposure part formed in each of the optical fibers 31.

Next, the configuration of the optical fiber connection device according to the exemplary embodiment of the present invention will be described in detail with reference to FIGS. 3 to 6.

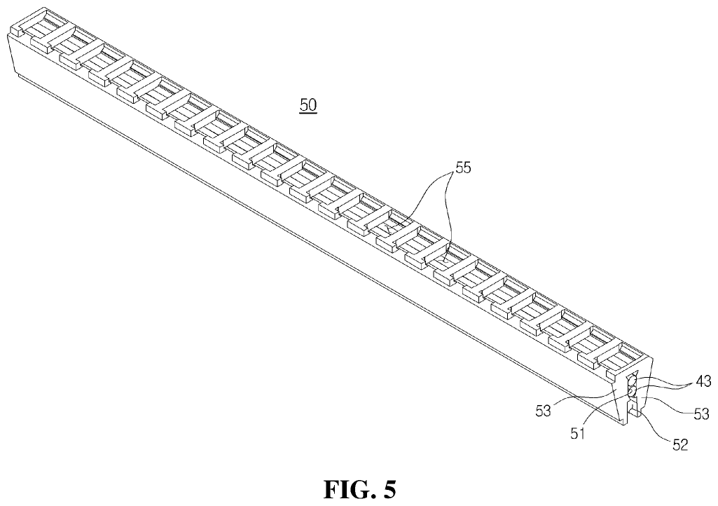

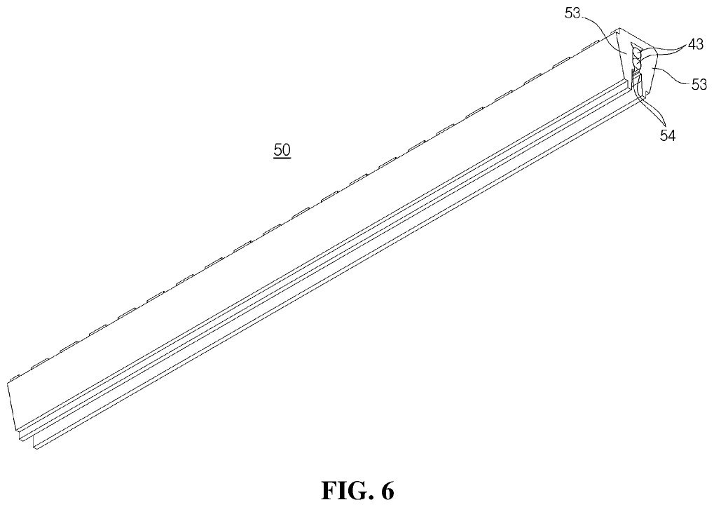

FIG. 5 is a perspective view showing the optical fiber connection device according to the exemplary embodiment of the present invention, and FIG. 6 is a perspective view showing the optical fiber connection device of FIG. 5 from another angle.

As shown in FIGS. 3 to 6, according to the exemplary embodiment of the present invention, the optical fiber connection device 50 may elongate and extend in a longitudinal direction of the installation object 11 so as to have a section having a shape corresponding to the coupling space 25 so that the optical fiber connection device 50 may be coupled into the coupling space 25 of the body 20.

For example, the section of the optical fiber connection device 50 may have a trapezoidal shape in which a lower side is shorter than an upper side.

The light source unit 40 may be disposed on an upper portion of the optical fiber connection device 50, and an arrangement space 51 in which a lens unit 43 for condensing the light emitted from the light source unit 40 in a line shape is disposed may be formed inside the optical fiber connection device 50.

A fixing space 52 in which the upper end of the optical fiber display 30 is fixed may be formed on a bottom surface of the optical fiber connection device 50 so as to communicate with the arrangement space 51.

In order to prevent the lens unit 43 disposed in the arrangement space from being separated, fixing ribs 54 may protrude from inner surfaces of both side walls 53 of the optical fiber connection device 50, respectively, so as to face each other.

As shown in FIG. 3, the light source unit 40 may include one or more light sources 42 installed on a printed circuit board 41 while being spaced apart from each other by a preset distance.

The light sources 42 may be driven according to a control signal of the control unit to emit lights having mutually different colors. However, the light sources 42 may emit lights having the same color or change colors of the emitted lights according to the control signal of the control unit. To this end, each of the light sources 42 may preferably be provided as a multi-color LED.

The optical fiber connection device 50 may be formed on a top surface thereof with one or more installation holes 55 in which the one or more light sources 42 provided in the light source unit 40 are installed.

Therefore, the installation hole 55, the arrangement space 51, and the fixing space 52 may be connected to each other and consecutively arranged.

The installation hole 55 may be formed at a position corresponding to a position in which each of the light sources 42 is disposed in a shape corresponding to a shape of each of the light sources 42.

The optical fiber connection device 50 configured as described above way may be provided as a module having a preset length, and the optical fiber connection device 50 may be configured such that one or more modules are consecutively connected to each other to correspond to the lateral length of the optical fiber display 30.

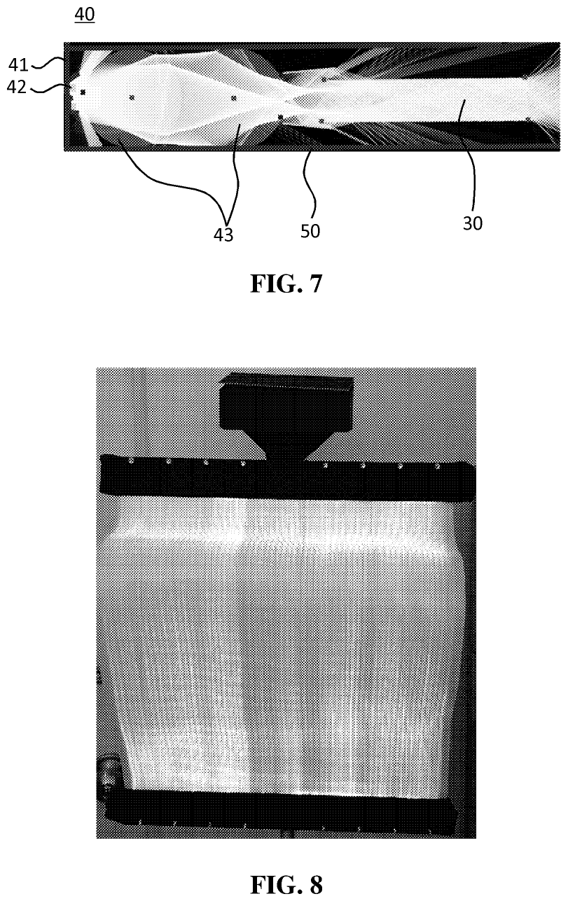

Meanwhile, FIG. 7 is a view illustrating a state in which a light emitted from a light source of a light source unit is emitted through a lens unit, and FIG. 8 is a view showing an actual lighting state of an optical fiber display.

As shown in FIG. 7, the light emitted from each of the light sources 42 may be condensed through the lens unit 43. In this case, the condensed light may be condensed in a line shape rather than a point shape so as to be incident into the one end of the optical fiber display 30.

To this end, the lens unit 43 may have a bar shape elongated and extending in a longitudinal direction of the optical fiber connection device 50 instead of a general ball shape, and one or more lens units 43 may be provided for the purpose of a refractive index and light condensation.

The lens unit 43 may be formed by using a transparent material such as a synthetic resin material such as glass, acryl, or polycarbonate, and may have a curved shape.

In other words, the lens unit 43 may be changed into various shapes such as an m-shape having a convex portion to evenly emit the light as well as a bar shape.

As described above, according to the present invention, a light emitted from the light source unit may be condensed in a line shape through the lens unit so as to be incident into the one end of the optical fiber display having a fabric shape, so that light efficiency may be improved.

In addition, according to the present invention, as shown in FIG. lights emitted from adjacent light sources may be mixed with each other while the lights emitted from the light sources are incident into the optical fiber display through the lens unit, so that the optical fiber display may display colors mixed with each other in addition to colors emitted from the light sources.

In other words, while a multi-color LED generally emits three primary colors of red, green, and blue, according to the present invention, the three primary colors may be mixed with each other to display various colors by adjusting the color emitted from the light source, a distance between the light sources, and the like, and a structure in which the optical fibers are arranged in the optical fiber display may be variously changed so that a three-dimensional effect may be obtained.

Accordingly, according to the present invention, various shapes such as pictures, designs, and characters may be displayed in various colors through the optical fiber display, so that a visual effect and an aesthetic impression may be improved.

Next, a coupling relation and an operation method of the optical fiber connection device and the display device applying the same according to the exemplary embodiment of the present invention will be described in detail.

First, a worker may couple and arrange the lens unit 43 into the arrangement space 51 formed inside the optical fiber connection device 50, and may couple the upper end of the optical fiber display 30 to the fixing space 52 that is formed in a lower portion of the arrangement space 51 to communicate with the arrangement space 51.

In addition, the worker may arrange the printed circuit board 41 of the light source unit 40 on the upper portion of the optical fiber connection device 50, and the printed circuit board 41 and the optical fiber connection device 50 may be coupled to each other such that the one or more light sources 42 are inserted into the installation holes 55 formed on a top surface of the optical fiber connection device 50, respectively.

The light source unit 40 and the optical fiber connection device 50 assembled through the above process may be arranged on one side of the coupling space 25 formed in the coupling part 22 of the body 20, and slidably coupled into the coupling space 25.

In this case, the pair of fixing members 27 may be installed between the pair of coupling members 26 provided in the coupling part 22.

Therefore, the optical fiber display 30 may be pressed by both side walls 53 of the optical fiber connection device 50 and the pair of coupling members 26 while the upper end of optical fiber display 30 is disposed between the pair of fixing members 27, so that the optical fiber display 30 may be firmly fixed to the body 20.

To this end, a thickness of the pair of fixing members 27 may be set to be equal to or slightly thicker than a width of the coupling space 25.

In addition, the fixing member 27 may be formed of a rubber or synthetic resin material to firmly fix the upper end of the optical fiber display 30 by using friction.

Alternatively, each of the pair of fixing members 27 may be configured such that an inner surface making contact with the upper end of the optical fiber display 30 is embossed or engraved with protrusions, ribs, and patterns having various shapes, so that the optical fiber display 30 may be prevented from sliding.

Finally, the worker may insert the installation object 11 into the installation space 23 of the body 20, fasten the fastening bolt to the fastening hole formed at an upper end of each of the installation members 24, and tighten the nut, so that the body 20 may be firmly assembled with the installation object 11.

Then, the control unit may supply the power to each of the light sources 42 provided in the light source unit 40, and may output a control signal for controlling driving of each of the light sources 42.

In this case, the control unit may control each of the light sources 42 to be lighted up in the same color or in mutually different colors.

In addition, the control unit may control each of the light sources 42 to change the color of the emitted light according to a preset period.

Through the process as described above, according to the present invention, the optical fiber display may be slidably coupled into a space provided in the optical fiber connection device, so that the light source unit and the optical fiber display may be easily connected to each other.

In addition, according to the present invention, a light emitted from the light source unit may be condensed in a line shape through the lens unit so as to be incident into the one end of the optical fiber display having a fabric shape, so that light efficiency may be improved.

In addition, according to the present invention, the lights emitted from the light sources may be mixed with each other while being incident into the optical fiber display through the lens unit, so that the optical fiber display may display colors mixed with each other in addition to colors emitted from the light sources.

Accordingly, according to the present invention, various shapes such as pictures, designs, and characters may be displayed in various colors through the optical fiber display, so that a visual effect and an aesthetic impression may be improved.

Although the present invention invented by the present inventor has been described in detail according to the above embodiments, the present invention is not limited to the embodiments, and various modifications can be made without departing from the gist of the present invention.

### INDUSTRIAL APPLICABILITY

The present invention may be applied to an optical fiber connection device and a display device technology applying the same, in which one end of an optical fiber display may be slidably coupled into a space provided in the optical fiber connection device, so that a light source unit and the optical fiber display may be easily connected to each other.

1. An optical fiber connection device for connecting a light source unit disposed on one surface of the optical fiber connection device to an optical fiber display, wherein the optical fiber connection device is formed therein with a fixing space to which one end of the optical fiber display is fixed through one surface of the optical fiber connection device, which is opened,
the optical fiber connection device is formed on an opposite surface thereof with one or more installation holes in which one or more light sources provided in the light source unit are installed, and an arrangement space in which a lens unit for condensing lights emitted from the light sources provided in the light source unit is disposed is formed between the installation holes and the fixing space.

2. The optical fiber connection device of claim 1, wherein the optical fiber connection device is provided as a module having a preset length, and the optical fiber connection device is configured such that one or more modules are connected each other to correspond to a length of the optical fiber display.

3. A display device applying an optical fiber connection device according to claim 1, the display device comprising:
a body detachably coupled to an installation object;
an optical fiber display fabricated by using one or more optical fibers;
a light source unit installed inside the body and including one or more light sources;
and the optical fiber connection device for connecting the light source unit to the optical fiber display so that a light emitted from the light source unit is incident into one end of the optical fiber display.

4. The display device of claim 3, further comprising a control unit for supplying a power to the light source unit and controlling driving of each of the light sources,
wherein the control unit controls driving of the light source unit so that the light sources emit lights having a same color or lights having mutually different colors.

5. The display device of claim 3, wherein the body includes:
an installation part in which the installation object is installed; and
a coupling part coupled to the optical fiber connection device and the optical fiber display,
the body is provided as a module having a preset length, and
the body is configured such that one or more modules are connected each other to correspond to a length of the optical fiber display.

6. The display device of claim 5, wherein the installation part is formed at a center thereof with an installation space in which the installation object is installed,
the installation part includes a pair of installation members separately provided on both sides of the installation space,
the coupling part is formed with a coupling space in which the light source unit, the optical fiber connection device, and the optical fiber display are coupled, and
the coupling part includes a pair of coupling members separately provided on both sides of the coupling space.

7. The display device of claim 3, wherein the light source unit includes:
the one or more light sources installed on a printed circuit board; and
a lens unit for condensing lights emitted from the light sources in a line shape to correspond to one end surface of the optical fiber display so that the condensed lights are incident into the one end of the optical fiber display,
lights emitted from adjacent light sources are mixed and transmitted to the optical fiber display through the lens unit, and
a control unit controls driving of each of the light sources to adjust a color of a light that is obtained through the mixing and displayed on the optical fiber display.

8. A display device applying an optical fiber connection device according to claim 2, the display device comprising:
a body detachably coupled to an installation object;
an optical fiber display fabricated by using one or more optical fibers;
a light source unit installed inside the body and including one or more light sources;
and the optical fiber connection device for connecting the light source unit to the optical fiber display so that a light emitted from the light source unit is incident into one end of the optical fiber display.
